(19) United States
(12) Patent Application Publication
(10) Pub. No.: US 2026/0342474 A1
(43) Pub. Date: Oct. 29, 2026

(54) HARDWARE IMPLEMENTED FORWARD ERROR CORRECTION FOR REMOTE DIRECT MEMORY ACCESS (RDMA)

(71) Applicant: Microsoft Technology Licensing, LLC, Redmond, WA (US)

(72) Inventors: Nadeen Yassir GEBARA, Seattle, WA (US); Assaf SHACHAM, Zichron Yaakov (IL); Yevgeny YANKILEVICH, Tirat Carmel (IL); Zhuolong YU, Kirkland, WA (US); Konstantin TARANOV, Zurich (CH); Mahmoud Shawky EL HADDAD, Newcastle, WA (US)

(21) Appl. No.: 19/187,589

(22) Filed: Apr. 23, 2025

(51) Int. Cl. H04L 1/00; H04L 1/1867; H04L 45/24

(52) U.S. Cl. CPC H04L 1/0043; H04L 1/1874; H04L 45/24

(57) ABSTRACT

An integrated circuit and method are disclosed for performing a remote direct memory access (RDMA) network operation with forward error correction (FEC) using an integrated circuit. A message is loaded from memory for transmission over a connection associated with a connection identifier. The message is logically divided into a first predetermined number of data blocks. A second predetermined number of parity blocks are determined based on the data blocks. The data blocks and parity blocks are transmitted using different source port numbers from a set of source port numbers associated with the connection identifier.

### BACKGROUND

Remote Direct Memory Access (RDMA) is a high-performance data transfer technology that enables direct memory access between networked computing devices, significantly reducing latency and increasing throughput. RDMA minimizes overhead by allowing a network device to bypass traditional networking stacks to read and/or write data directly into the memory of another network device. An RDMA operations (e.g., RDMA send, RDMA, write, RDMA read response, etc.) allow a sender to access a memory region in a remote device directly.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Hardware-based systems and methods are disclosed for performing RDMA network operations with forward error correction (FEC) using an integrated circuit. The integrated circuit receives an RDMA work request to send a message to a receive buffer of a destination node. The integrated circuit performs FEC tasks based on the message to generate error correction code. The message and the error correction code are transmitted to the destination node.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of an example system for performing an RDMA operation with FEC using an integrated circuit, in accordance with an embodiment.

FIG. 2 shows a block diagram of an example system for processing a request to perform an RDMA operation with FEC using an integrated circuit, in accordance with an embodiment.

FIG. 3 shows a flowchart of an example process for performing an RDMA operation with FEC using an integrated circuit, in accordance with an embodiment.

FIG. 4 shows a flowchart of an example process for determining parity blocks using a mathematical lookup module, in accordance with an embodiment.

FIG. 5 shows a flowchart of an example process for performing Galois field multiplication using a lookup table, in accordance with an embodiment.

FIG. 6 depicts a flowchart of an example process for transmitting packets over diverse network paths, in accordance with an embodiment.

FIG. 7 shows a flowchart of an example process for remediating network degradation along a network path, in accordance with an embodiment.

FIG. 8 shows a flowchart of an example process for processing a request to perform an RDMA operation with FEC using an integrated circuit, in accordance with an embodiment.

FIG. 9 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

RDMA is a technology that enables direct data transfer between the memory of two computing systems over a network, significantly reducing latency and increasing throughput. RDMA minimizes overhead by allowing a network device to bypass traditional networking stacks to read and/or write data directly into the memory of another network device. RDMA is commonly used in high-performance computing (HPC), distributed databases, and storage systems to enable low-latency, high-throughput data transfers. The use of RDMA enhances workloads such as, but not limited to, AI/ML training, cloud computing, and/or financial trading, where fast, direct memory access improves performance. By reducing CPU overhead and enabling direct data movement, RDMA accelerates data-intensive applications across supercomputing, enterprise storage, and/or high-speed networking environments.

RDMA network operations include one-sided operations, such as RDMA write (e.g., to directly write data into remote memory) and RDMA read (e.g., to fetch data from remote memory), where the initiating party participates, and two-sided operations, such as RDMA send/receive, where both the sender and the receiver participate. Additionally, an RDMA write (or RDMA send) with immediate operation is an RDMA operation that further generates an event at the receiver to notify the receiver of an immediate value.

RDMA network operations are supported over various transport types, such as a reliable connection, a reliable datagram, unreliable connection, and an unreliable datagram. Reliable transport mechanisms, such as reliable connections and reliable datagrams, are commonly employed to handle packet retransmissions, acknowledgments, and flow control at the hardware level. A reliable connection is connection-oriented RDMA transport type that guarantees in-order, lossless, and acknowledged delivery of messages, making it suitable for applications requiring data integrity and consistency. However, each RDMA reliable connection requires dedicated resources on the RDMA network interface card, which can limit scalability in large-scale systems. A reliable datagram is a connectionless RDMA transport type that provides reliable, in-order datagram delivery while avoiding the overhead of maintaining dedicated connections. However, these reliable transport mechanisms result in significant overhead costs. Furthermore, packet retransmissions result in significant latency costs that are incompatible with certain high-performance applications that do not require strict reliability.

The inventive technology described herein overcomes these issues in conventional RDMA systems. In particular, disclosed herein is an integrated circuit with integrated forward error correction (FEC) for the performance of RDMA network operations (e.g., RDMA write, RDMA send, RDMA read response, etc.). Implementation of FEC for the performance of RDMA network operations on the integrated circuit further accelerates operations by offloading connection management and parity block generation from the application level onto the integrated circuit. Offloading connection management to the hardware level reduces overhead costs by employing a single unreliable connection. Furthermore, implementation of FEC for the performance of RDMA network operations on the integrated circuit allows for the acceleration of operations related to logically divide the message into the data blocks and to generate the parity blocks based on the data blocks. For instance, the integrated circuit implements these operations using a multi-stage pipeline that results in improved performance compared to performing these operations at the application level.

The implementation of FEC in an integrated circuit provides further advantages for the performance of RDMA network operations. For instance, an error correction module of the integrated circuit logically divides the message into a first number of data blocks and generates a second number of parity blocks (e.g., erasure codes, etc.) based on the data blocks, and a network module of the integrated circuit transmits the data blocks and parity blocks to the receive buffer using different source port numbers over diverse network paths. The parity blocks enable the receiver to reconstruct the message when at least some of the data blocks and/or parity blocks are lost and/or corrupted, and the use of diverse network paths decreases the likelihood of unsuccessful transmission of multiple data blocks and/or parity blocks. This approach improves the reliable transmission of messages over an unreliable connection thereby reducing overhead costs associated with reliable connections and/or reliable datagrams. Furthermore, this approach reduces the need for data retransmissions that are associated with high latency costs. The integrated circuit further includes a mathematical lookup module to accelerate calculations related to the generation of the parity blocks.

These and further embodiments enable the functionality described above and additional functionality. Such embodiments are described in further detail as follows.

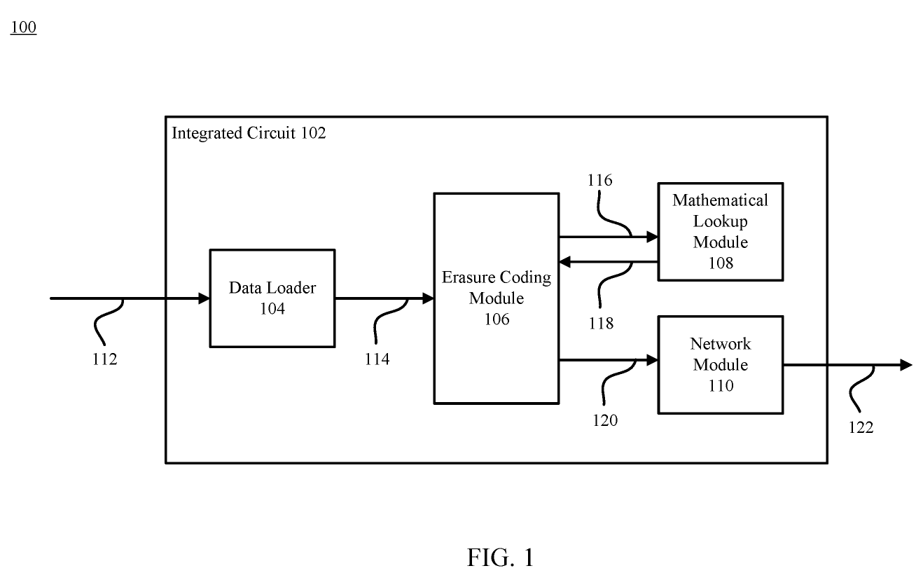

For example, FIG. 1 shows a block diagram of an example system 100 for performing an RDMA operation with FEC using an integrated circuit, in accordance with an embodiment. As shown in FIG. 1, system 100 includes an integrated circuit 102 comprising a data loader 104, an erasure coding module 106, a mathematical lookup module 108, and a network module 110. System 100 is described in further detail as follows.

Integrated circuit 102 comprises any circuit device capable of performing the functions ascribed thereto in the following description, as will be appreciated by persons skilled in the relevant art(s), including those mentioned elsewhere herein or otherwise known. In embodiments, integrated circuit 102 comprises various subcomponents (not shown), such as, but not limited to, logic blocks, interconnects that connect the logic blocks, I/O blocks, and/or block RAM. In embodiments, integrated circuit 102 is implemented using, for example, but not limited to, a field-programmable gate array (FPGA), an application-specific integrated circuit (ASIC), and/or the like.

Data loader 104 is configured to load a message 112 for transmission over an unreliable connection. In embodiments, data loader 104 provides message 112 to erasure coding module 106. In instances, data loader 104 loads message 112 into an on-chip memory of integrated circuit 102 that is accessible to erasure coding module 106.

Erasure coding module 106 is configured to logically divide message 112 into a first predetermined number of data blocks, and determine a second predetermined number of parity blocks based on the data blocks. In configurations, erasure coding module 106 employs mathematical lookup module 108 to determine the parity blocks. For instance, erasure coding module 106 determines index values corresponding to the data blocks, and provides a series of data block and index value pairs 114 to mathematical lookup module 108. Erasure coding module 106 receives a series of output values 116 from mathematical lookup module 108, and performs exclusive-OR (XOR) operations across the series of output values 116 to generate the parity blocks. In an embodiment, the parity blocks are erasure codes determined based on various algorithms, such as, but not limited to, Reed-Solomon coding algorithm. Erasure coding module 106 provides the data blocks and parity blocks to network module 110 as blocks 118.

Mathematical lookup module 108 is configured to accelerate Galois field multiplication operations by performing lookup operations on a lookup table that includes a multiplication table of precomputed outcomes of Galois field multiplication operations. In embodiments, mathematical lookup module 108 receives a data block and index value pair, and determines an entry in the lookup table based on the index value. Mathematical lookup module 108, in instances, determines values in the entry corresponding to fixed-width (e.g., 4-bit, 8-bit, etc.) portions of the data block by performing shuffle operations on the entry of the lookup table based on values of the fixed-width portions, and provides output value 116 comprising a concatenation of the determined values. In configurations, the shuffle operations of mathematical lookup module 108 are performed in parallel to simultaneously determine the values in the entry corresponding to fixed-width portions of the data block.

Network module 110 is configured to transmit blocks 118 (e.g., data blocks, parity blocks) to a specific destination receive buffer using diverse network paths. In embodiments, network module 110 determines a set of source port numbers (e.g., User Datagram Protocol (UDP) source port numbers) associated with a connection identifier of the unreliable connection, and transmits each block of blocks 118 (e.g., data blocks, parity blocks) using a different source port number. For instance, network module 110 generates packets 120, such as, but not limited to, UDP packets, to encapsulate blocks 118, and include a different source port number of the set of source port numbers in the header (e.g., UDP header) of packets 120. In configurations, network module 110 transmits packets 120 to a network node that is configured to perform equal-cost multi-path (ECMP) routing. In an embodiment, the network node performs ECMP routing by hashing the headers of packets 120 and routing packets 120 over diverse network paths based on the hash value. The use of different source port numbers by network module 110 results in the transmission of packets 120 over diverse network paths.

In configurations, network module 110 is configured to transmit packets 120. For instance, network module 110 includes, in packets 120, an immediate value that comprises a message identifier associated with message 112, and at least one of: a block identifier that identifies a block (e.g., data block, parity block) of blocks 118 in a packet of packets 120, or a path identifier associated with a transmission path of a packet of packets 120. In instances, upon writing of message 112 to the destination receive buffer, an event is triggered to notify the destination computing device of the immediate value to enable the destination computing device to reconstruct message 112 from blocks 118 in packets 120. For instance, the destination computing device can reconstruct message 112 by concatenating the data blocks in blocks 118 based on the block identifiers in the immediate values of packets 120 and/or by computing any missing data blocks using one or more data blocks and/or parity blocks of blocks 118 in packets 120 based on the block identifiers in the immediate values of packets 120.

In embodiments, network module 110 is further configured to dynamically change the network paths employed by an unreliable connection by changing the source port numbers. For instance, upon detection of degradation on a network path associated with a first source port number, network module 110 is configured to replace the first source port number in the set of source port numbers associated with the connection identifier. In instances, network module 110 dynamically changes the network paths employed by an unreliable connection based on the satisfaction of a performance condition associated with a network path. For instance, a performance condition is satisfied when a metric associated with a network path, such as, but not limited to, packet loss metric, latency metric, congestion metric, and/or the like, exceeds a predetermined metric threshold.

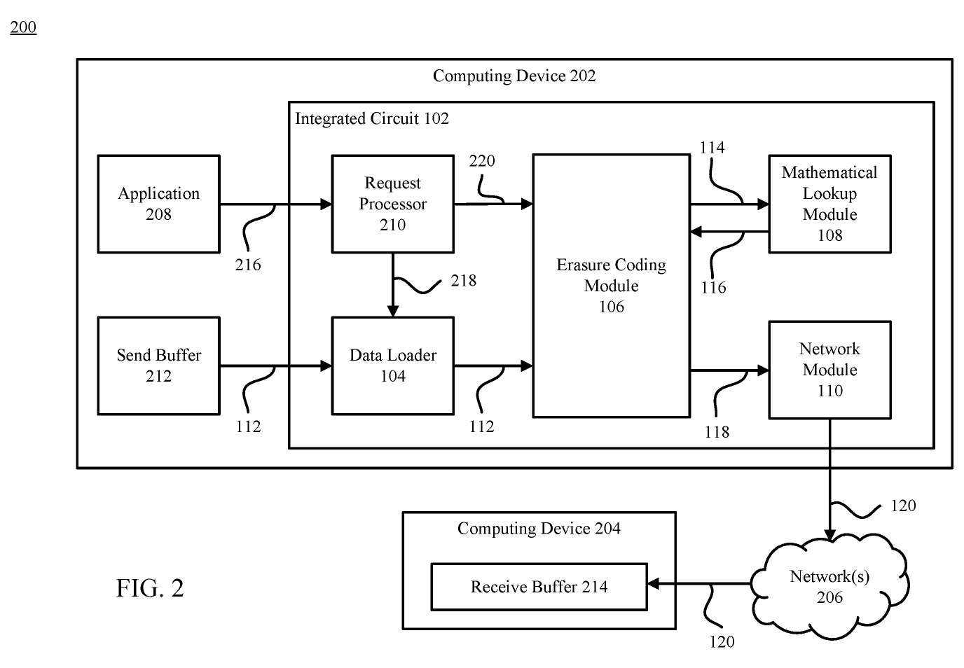

Embodiments described herein may operate in various ways to process a request to perform an RDMA operation with FEC using an integrated circuit. For instance, FIG. 2 shows a block diagram of an example system 200 for processing a request to perform an RDMA operation with FEC using an integrated circuit, in accordance with an embodiment. As shown in FIG. 2, system 200 comprises a computing device 202, and a computing device 204 that are communicatively coupled via one or more networks 206. In system 200, computing device 202 includes integrated circuit 102, an application 208, and a send buffer 212, and computing device 204 includes a receive buffer 214. Integrated circuit 102 includes data loader 104, erasure coding module 106, mathematical lookup unit 108, network module 110, and a request processor 210. System 200 is described in further detail as follows.

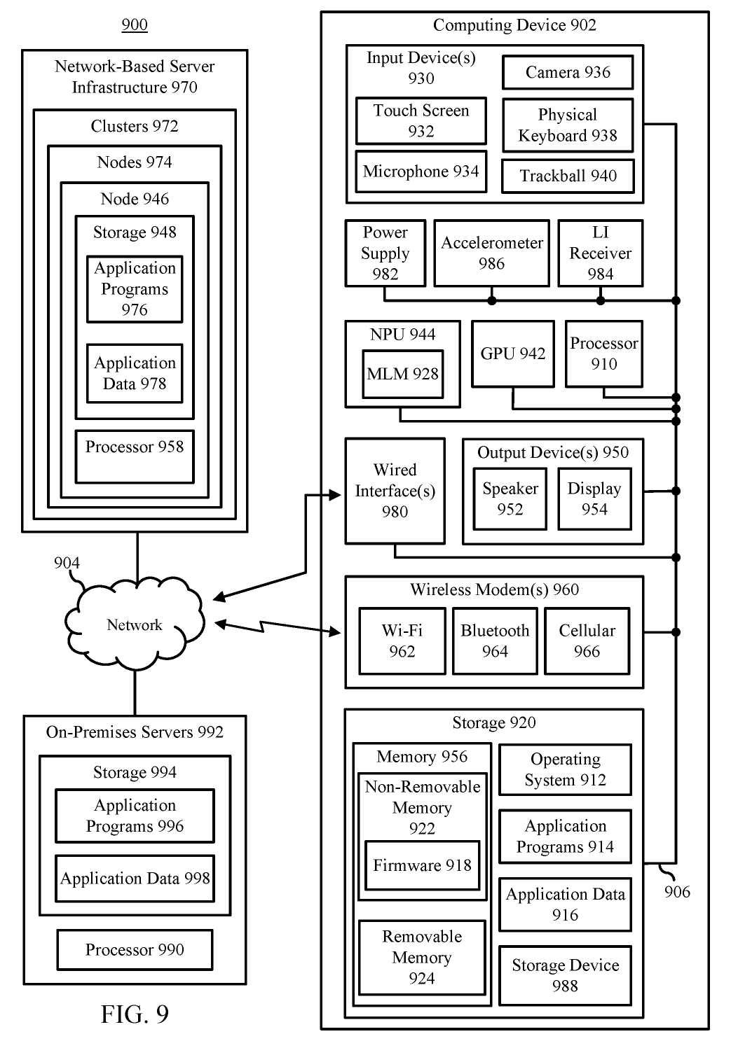

Computing device 202 includes any computing device suitable for performing functions that are ascribed thereto in the following description, as will be appreciated by persons skilled in the relevant art(s), including those mentioned elsewhere herein or otherwise known. For instance, computing device 202 comprises any computing device configured to perform RDMA network operations. In embodiments, computing device 202 is configured to perform an RDMA network operation to send a message from send buffer 212 on computing device 202 to a receive buffer 214 on computing device 204. Various example implementations of computing device 202 are described below in reference to FIG. 9 (e.g., computing device 902, nodes 974 of network-based server infrastructure 970, on-premises servers 1092, and/or components thereof).

Computing device 204 includes any computing device suitable for performing functions that are ascribed thereto in the following description, as will be appreciated by persons skilled in the relevant art(s), including those mentioned elsewhere herein or otherwise known. For instance, computing device 204 comprises any computing device configured to perform RDMA network operations. In embodiments, computing device 204 is configured to receive, in receive buffer 214, a message sent from send buffer 212 on computing device 202. Various example implementations of computing device 204 are described below in reference to FIG. 9 (e.g., computing device 902, nodes 974 of network-based server infrastructure 970, on-premises servers 1092, and/or components thereof).

Network(s) 206 comprise any computing device or plurality of computing devices suitable for performing functions that are ascribed thereto in the following description, as will be appreciated by persons skilled in the relevant art(s), including those mentioned elsewhere herein or otherwise known. For instance, network(s) 206 comprises one or more networks, such as, but not limited to, local area networks (LANs), wide area networks (WANs), mobile networks, cellular networks, satellite networks, enterprise networks, the Internet, and/or the like, and includes one or more wired and/or wireless portions. Various example implementations of network(s) 206 are described below in reference to FIG. 9 (e.g., network 904, and/or components thereof).

Application 208 comprises any application or applications suitable for performing functions that are ascribed thereto in the following description, as will be appreciated by persons skilled in the relevant art(s), including those mentioned elsewhere herein or otherwise known. For instance, application 208 comprises any application capable of initiating an RDMA operation to read, write, send, respond to a read request, and/or receive messages to and/or from a networked computing device (e.g., computing device 204). Various example implementations of computing device 204 are described below in reference to FIG. 9 (e.g., application programs 914, application programs 976, and/or application programs 996).

Request processor 210 is configured to receive and process a request 216 to transmit message 112 from send buffer 212 on computing device 202 to receive buffer 214 on computing device 204. In embodiments, request 216 includes various information, such as, but not limited to, a request identifier, a connection identifier, a local address of send buffer 212 that contains message 112, a length of message 112, a message identifier for inclusion in an immediate value, a remote address of receive buffer 214 as a destination for message 112, a memory key associated with receive buffer 214, a first parameter indicating the number of data blocks to logically divide message 112 into, a second parameter indicating the number of parity blocks to generate from the data blocks, and/or the like. In instances, request processor 210 provides information 218, such as, but not limited to, a connection identifier, a local address of send buffer 212 that contains message 112, a length of message 112, and/or the like, to data loader 104 to enable data loader 104 to load message 112 from send buffer 212. In configurations, request processor 210 provides parameters, 220, such as, but not limited to, a message identifier for inclusion in an immediate value, a remote address of receive buffer 214 as a destination for message 112, a memory key associated with receive buffer 214, a first parameter indicating the number of data blocks to logically divide message 112 into, a second parameter indicating the number of parity blocks to generate from the data blocks, and/or the like, to erasure coding module 106 and/or network module 110 to enable erasure coding module 106 logically divide message 112 into the first predetermined number of data blocks and generate parity blocks based on the data blocks, and/or to enable network module 110 to generate packets 120.

Send buffer 212 comprises one or more regions of memory used to store data that will be sent over a network using an RDMA operation. In embodiments, send buffer 212 resides in a local memory of computing device 202, and is associated with a request 216 that specifies message 112 to be transmitted. For instance, upon processing of request 216 by request processor 210, data loader 104 loads message 112 from send buffer 212 for transmission to receive buffer 214. In instances, send buffer 212 on computing device 202 and receive buffer 214 on computing device 204 are linked by a queue pair (QP).

Receive buffer 214 comprises one or more regions of memory used to receive data from a remote node during an RDMA operation. In embodiments, receive buffer 214 resides in a local memory of computing device 204, and is associated with request 216 which specifies where the message 112 should be placed in memory. In instances, send buffer 212 on computing device 202 and receive buffer 214 on computing device 204 are linked by a queue pair (QP). In configurations, when message 112 is written to receive buffer 214, an event is triggered to provide an immediate value associated with the operation.

Embodiments described herein may operate in various ways to perform an RDMA operation with FEC using an integrated circuit. For instance, FIG. 3 depicts a flowchart 300 of a process for performing an RDMA operation with FEC using an integrated circuit, in accordance with an embodiment. Integrated circuit 102, data loader 104, erasure coding module 106, mathematical lookup module 108, network module 110, computing device 202, request processor 210, and/or send buffer 212 may, for example, operate according to flowchart 300. Note that not all steps of flowchart 300 need to be performed in all embodiments, and in some embodiments, the steps of flowchart 300 may be performed in different orders than shown. Flowchart 300 is described as follows with respect to FIGS. 1 and 2 for illustrative purposes.

Flowchart 300 starts at step 302. In step 302, a message is loaded from memory, the message associated with a connection identifier. For instance, data loader 104 loads message 112 from send buffer 212, and provides message 112 to erasure coding module 106. In instances, data loader 104 loads message 112 into an on-chip memory of integrated circuit 102 that is accessible to erasure coding module 106. In a configuration, data loader 104 load message 112 based on information 218, such as, but not limited to, a connection identifier, a local address of send buffer 212 that contains message 112, a length of message 112, and/or the like, that is provided by request processor 210.

In step 304, the message is logically divided into a first predetermined number of data blocks. For instance, erasure coding module 106 logically divides message 112 into a first predetermined number of data blocks.

In step 306, a second predetermined number of parity blocks are determined based on the data blocks. For instance, erasure coding module 106 determines a second predetermined number of parity blocks based on the data blocks. In an embodiment, the parity blocks are erasure codes determined based on various algorithms, such as, but not limited to, Reed-Solomon coding algorithm.

In step 308, a set of source port numbers associated with the connection identifier is determined. For instance, network module 110 determines a set of source port numbers (e.g., UDP source port numbers) associated with a connection identifier of the unreliable connection.

In step 310, the data blocks and parity blocks are transmitted using different source port numbers from the set of source port numbers. For instance, network module 110 transmits each block of blocks 118 (e.g., data blocks, parity blocks) using a different source port number.

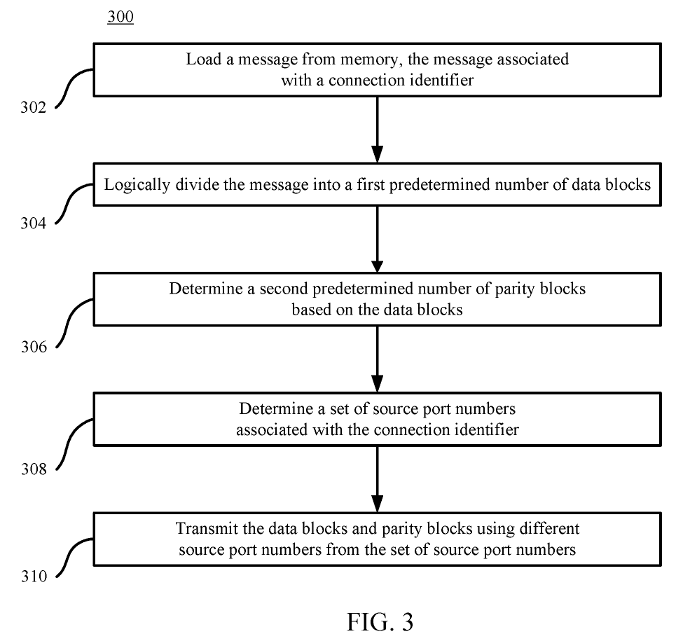

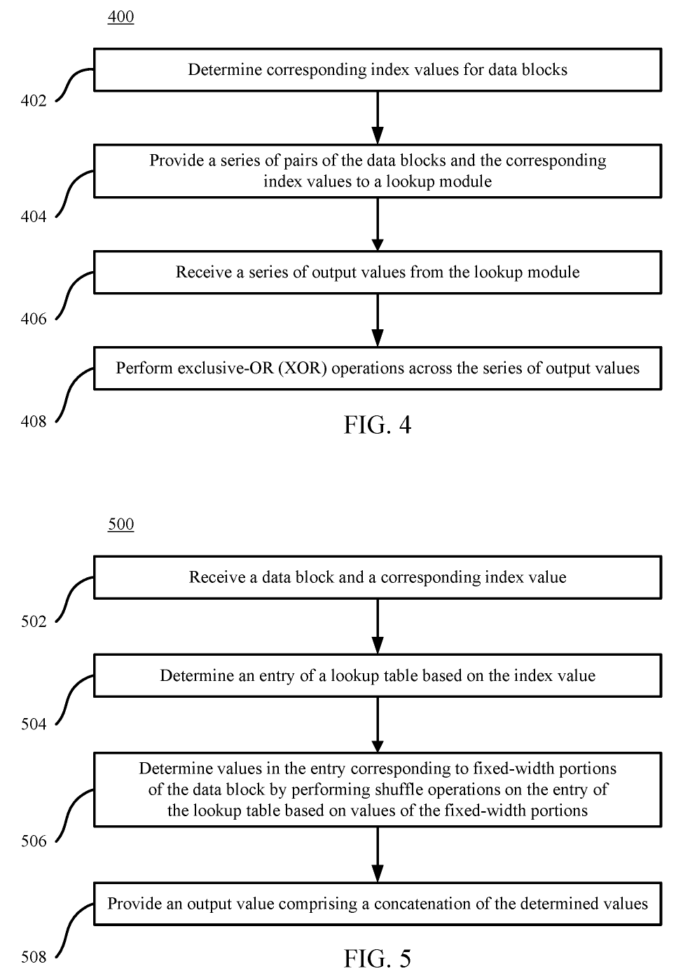

Embodiments described herein may operate in various ways to determine parity blocks using a mathematical lookup module. For instance, FIG. 4 depicts a flowchart 400 of a process for determining parity blocks using a mathematical lookup module, in accordance with an embodiment. Integrated circuit 102, erasure coding module 106, mathematical lookup module 108, and/or computing device 202 may, for example, operate according to flowchart 400. Note that not all steps of flowchart 400 need to be performed in all embodiments, and in some embodiments, the steps of flowchart 400 may be performed in different orders than shown. Flowchart 400 is described as follows with respect to FIG. 1 for illustrative purposes.

Flowchart 400 starts at step 402. In step 402, corresponding index values are determined for data blocks. For instance, erasure coding module 106 determines index values corresponding to the data blocks.

In step 404, a series of pairs of the data blocks and corresponding index values are provided to a lookup module. For instance, erasure coding module 106 provides a series of data block and index value pairs 114 to mathematical lookup module 108.

In step 406, a series of output values are received from the lookup module. For instance, erasure coding module 106 receives a series of output values 116 from mathematical lookup module 108.

In step 408, XOR operations are performed across the series of output values. For instance, erasure coding module 106 performs XOR operations across the series of output values 116 to generate the parity blocks.

Embodiments described herein may operate in various ways to perform Galois field multiplication using a lookup table. For instance, FIG. 5 depicts a flowchart 500 of a process for performing Galois field multiplication using a lookup table, in accordance with an embodiment. Integrated circuit 102, mathematical lookup module 108, and/or computing device 202 may, for example, operate according to flowchart 500. Flowchart 500 is described as follows with respect to FIGS. 1 and 2 for illustrative purposes.

Flowchart 500 starts at step 502. In step 502, a data block and corresponding index value are received. For instance, mathematical lookup module 108 receives a data block and index value pair.

In step 504, an entry of a lookup table is determined based on the index value. For instance, mathematical lookup module 108 determines an entry in the lookup table based on the index value.

In step 506, values in the entry corresponding to fixed-width portions of the data block by performing shuffle operations on the entry of the lookup table based on values of the fixed-width portions. For instance, mathematical lookup module 108 determines values in the entry corresponding to fixed-width (e.g., 4-bit, 8-bit, etc.) portions of the data block by performing shuffle operations on the entry of the lookup table based on values of the fixed-width portions.

In step 508, an output value is provided, the output value comprising a concatenation of the determined values. For instance, mathematical lookup module 108 provides, to erasure coding module 106, output value 116 comprising a concatenation of the determined values.

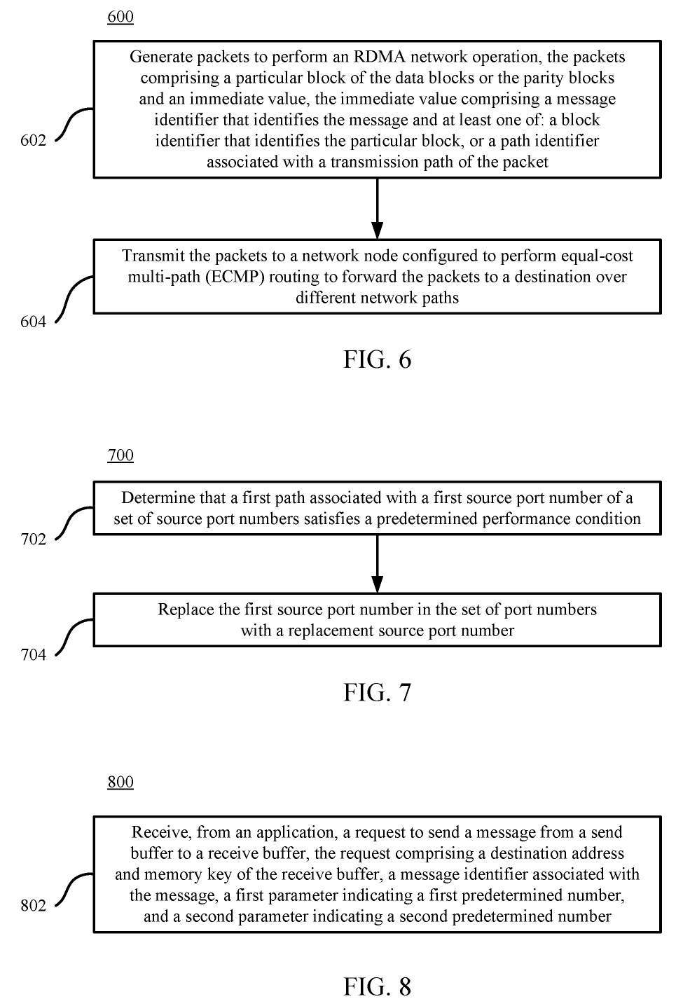

Embodiments described herein may operate in various ways to transmit packets over diverse network paths. For instance, FIG. 6 depicts a flowchart 600 of a process for transmitting packets over diverse network paths, in accordance with an embodiment. Integrated circuit 102, erasure coding module 106, network module 110, and/or computing device 202 may, for example, operate according to flowchart 600. Note that not all steps of flowchart 600 need to be performed in all embodiments, and in some embodiments, the steps of flowchart 600 may be performed in different orders than shown. Flowchart 600 is described as follows with respect to FIGS. 1 and 2 for illustrative purposes.

Flowchart 600 starts at step 602. In step 602, packets are generated to perform an RDMA network operation, the packets comprising a particular block of the data blocks or the parity blocks and an immediate value, the immediate value comprising a message identifier that identifies the message and at least one of: a block identifier that identifies the particular block, or a path identifier associated with a transmission path of the packet. For instance, network module 110 generates packets 120 to perform an RDMA network operation by including immediate values in packets 120, the immediate value comprising a message identifier associated with message 112, and at least one of: a block identifier that identifies a block (e.g., data block, parity block) of blocks 118 in a packet of packets 120, or a path identifier associated with a transmission path of a packet of packets 120.

In step 604, the packets are transmitted to a network node configured to perform ECMP routing to forward the packets to a destination over different network paths. For instance, network module 110 transmits packets 120 to a network node that is configured to perform equal-cost multi-path (ECMP) routing. In an embodiment, the network node performs ECMP routing by hashing the headers of packets 120 and routing packets 120 over diverse network paths based on the hash value, and the use of different source port numbers by network module 110 results in the transmission of packets 120 over diverse network paths.

Embodiments described herein may operate in various ways to remediate network degradation along a network path. For instance, FIG. 7 depicts a flowchart 700 of a process for remediating network degradation along a network path, in accordance with an embodiment. Integrated circuit 102, network module 110, and/or computing device 202 may, for example, operate according to flowchart 700. Note that not all steps of flowchart 700 need to be performed in all embodiments, and in some embodiments, the steps of flowchart 700 may be performed in different orders than shown. Flowchart 700 is described as follows with respect to FIGS. 1 and 2 for illustrative purposes.

Flowchart 700 starts at step 702. In step 702, it is determined that a first path associated with a first source port number of a set of source port numbers satisfies a predetermined performance condition. For instance, network module 110 determines that a performance condition of a first network path associated with a first source port number is satisfied when a metric associated with a first network path, such as, but not limited to, packet loss metric, latency metric, congestion metric, and/or the like, exceeds a predetermined metric threshold.

In step 704, the first source port number in the set of port numbers is replaced with a replacement source port number. For instance, network module 110 dynamically changes the network paths employed by an unreliable connection by replacing a first source port number with a replacement source port number.

Embodiments described herein may operate in various ways to process a request to perform an RDMA operation with FEC using an integrated circuit. For instance, FIG. 8 depicts a flowchart 800 of a process for processing a request to perform an RDMA operation with FEC using an integrated circuit, in accordance with an embodiment. Integrated circuit 102, data loader 104, computing device 202, request processor 210, and/or send buffer 212 may, for example, operate according to flowchart 800. Flowchart 800 is described as follows with respect to FIGS. 1 and 2 for illustrative purposes.

Flowchart 800 starts at step 802. In step 802, a request to send a message from a send buffer to a receive buffer is received from an application, the request comprising a destination address and memory key of the receive buffer, a message identifier associated with the message, a first parameter indicating a first predetermined number, and a second parameter indicating a second predetermined number. For instance, request processor 210 receives a request 216 to transmit message 112 from send buffer 212 on computing device 202 to receive buffer 214 on computing device 204, request 216 includes various information, such as, but not limited to, a request identifier, a connection identifier, a local address of send buffer 212 that contains message 112, a length of message 112, a message identifier for inclusion in an immediate value, a remote address of receive buffer 214 as a destination for message 112, a memory key associated with receive buffer 214, a first parameter indicating the number of data blocks to logically divide message 112 into, a second parameter indicating the number of parity blocks to generate from the data blocks, and/or the like.

### III. EXAMPLE MOBILE DEVICE AND COMPUTER SYSTEM IMPLEMENTATION

Integrated circuit 102, data loader 104, erasure coding module 106, mathematical lookup module 108, network module 110, computing device 202, computing device 204, network(s) 206, application 208, request processor 210, send buffer 212, and/or receive buffer 214 are implemented in hardware, or hardware combined with one or both of software and/or firmware. For example, application 208, and/or the components described therein, and/or the steps of flowcharts 300, 400, 500, 600, 700, and/or 800 are each implemented as computer program code/instructions configured to be executed in one or more processors and stored in a computer readable storage medium. Alternatively, integrated circuit 102, data loader 104, erasure coding module 106, mathematical lookup module 108, network module 110, computing device 202, computing device 204, network(s) 206, request processor 210, send buffer 212, and/or receive buffer 214, and/or the components described therein, and/or the steps of flowcharts 300, 400, 500, 600, 700, and/or 800 are implemented in one or more SoCs (system on chip). A SoC includes an integrated circuit chip that includes one or more of a processor (e.g., a central processing unit (CPU), microcontroller, microprocessor, digital signal processor (DSP), etc.), memory, one or more communication interfaces, and/or further circuits, and optionally executes received program code and/or include embedded firmware to perform functions.

Embodiments disclosed herein can be implemented in one or more computing devices that are mobile (a mobile device) and/or stationary (a stationary device) and include any combination of the features of such mobile and stationary computing devices. Examples of computing devices in which embodiments are implementable are described as follows with respect to FIG. 9. FIG. 9 shows a block diagram of an exemplary computing environment 900 that includes a computing device 902. Computing device 902 is an example of computing device 202 and/or computing device 204, which each include one or more of the components of computing device 902. In some embodiments, computing device 902 is communicatively coupled with devices (not shown in FIG. 9) external to computing environment 900 via network 904. Network 904 comprises one or more networks such as local area networks (LANs), wide area networks (WANs), enterprise networks, the Internet, etc. In examples, network 904 includes one or more wired and/or wireless portions. In some examples, network 904 additionally or alternatively includes a cellular network for cellular communications. Computing device 902 is described in detail as follows.

Computing device 902 can be any of a variety of types of computing devices. Examples of computing device 902 include a mobile computing device such as a handheld computer (e.g., a personal digital assistant (PDA)), a laptop computer, a tablet computer, a hybrid device, a notebook computer, a netbook, a mobile phone (e.g., a cell phone, a smart phone, etc.), a wearable computing device (e.g., a head-mounted augmented reality and/or virtual reality device including smart glasses), or other type of mobile computing device. In an alternative example, computing device 902 is a stationary computing device such as a desktop computer, a personal computer (PC), a stationary server device, a minicomputer, a mainframe, a supercomputer, etc.

As shown in FIG. 9, computing device 902 includes a variety of hardware and software components, including a processor 910, a storage 920, a graphics processing unit (GPU) 942, a neural processing unit (NPU) 944, one or more input devices 930, one or more output devices 950, one or more wireless modems 960, one or more wired interfaces 980, a power supply 982, a location information (LI) receiver 984, and an accelerometer 986. Storage 920 includes memory 956, which includes non-removable memory 922 and removable memory 924, and a storage device 988. Storage 920 also stores an operating system 912, application programs 914, and application data 916. Wireless modem(s) 960 include a Wi-Fi modem 962, a Bluetooth modem 964, and a cellular modem 966. Output device(s) 950 includes a speaker 952 and a display 954. Input device(s) 930 includes a touch screen 932, a microphone 934, a camera 936, a physical keyboard 938, and a trackball 940. Not all components of computing device 902 shown in FIG. 9 are present in all embodiments, additional components not shown may be present, and in a particular embodiment any combination of the components are present. In examples, components of computing device 902 are mounted to a circuit card (e.g., a motherboard) of computing device 902, integrated in a housing of computing device 902, or otherwise included in computing device 902. The components of computing device 902 are described as follows.

In embodiments, a single processor 910 (e.g., central processing unit (CPU), microcontroller, a microprocessor, signal processor, ASIC (application specific integrated circuit), and/or other physical hardware processor circuit) or multiple processors 910 are present in computing device 902 for performing such tasks as program execution, signal coding, data processing, input/output processing, power control, and/or other functions. In examples, processor 910 is a single-core or multi-core processor, and each processor core is single-threaded or multithreaded (to provide multiple threads of execution concurrently). Processor 910 is configured to execute program code stored in a computer readable medium, such as program code of operating system 912 and application programs 914 stored in storage 920. The program code is structured to cause processor 910 to perform operations, including the processes/methods disclosed herein. Operating system 912 controls the allocation and usage of the components of computing device 902 and provides support for one or more application programs 914 (also referred to as “applications” or “apps”). In examples, application programs 914 include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. In examples, processor(s) 910 includes one or more general processors (e.g., CPUs) configured with or coupled to one or more hardware accelerators, such as one or more NPUs 944 and/or one or more GPUs 942.

Any component in computing device 902 can communicate with any other component according to function, although not all connections are shown for ease of illustration. For instance, as shown in FIG. 9, bus 906 is a multiple signal line communication medium (e.g., conductive traces in silicon, metal traces along a motherboard, wires, etc.) present to communicatively couple processor 910 to various other components of computing device 902, although in other embodiments, an alternative bus, further buses, and/or one or more individual signal lines is/are present to communicatively couple components. Bus 906 represents one or more of any of several types of bus structures, including a memory bus or memory controller, a peripheral bus, an accelerated graphics port, and a processor or local bus using any of a variety of bus architectures.

Storage 920 is physical storage that includes one or both of memory 956 and storage device 988, which store operating system 912, application programs 914, and application data 916 according to any distribution. Non-removable memory 922 includes one or more of RAM (random access memory), ROM (read only memory), flash memory, a solid-state drive (SSD), a hard disk drive (e.g., a disk drive for reading from and writing to a hard disk), and/or other physical memory device type. In examples, non-removable memory 922 includes main memory and is separate from or fabricated in a same integrated circuit as processor 910. As shown in FIG. 9, non-removable memory 922 stores firmware 918 that is present to provide low-level control of hardware. Examples of firmware 918 include BIOS (Basic Input/Output System, such as on personal computers) and boot firmware (e.g., on smart phones). In examples, removable memory 924 is inserted into a receptacle of or is otherwise coupled to computing device 902 and can be removed by a user from computing device 902. Removable memory 924 can include any suitable removable memory device type, including an SD (Secure Digital) card, a Subscriber Identity Module (SIM) card, which is well known in GSM (Global System for Mobile Communications) communication systems, and/or other removable physical memory device type. In examples, one or more of storage device 988 are present that are internal and/or external to a housing of computing device 902 and are or are not removable. Examples of storage device 988 include a hard disk drive, an SSD, a thumb drive (e.g., a USB (Universal Serial Bus) flash drive), or other physical storage device.

One or more programs are stored in storage 920. Such programs include operating system 912, one or more application programs 914, and other program modules and program data. Examples of such application programs include computer program logic (e.g., computer program code/instructions) for implementing application 208, and/or each of the components described therein, as well as any of flowcharts 300, 400, 500, 600, 700, 800, and/or any individual steps thereof.

Storage 920 also stores data used and/or generated by operating system 912 and application programs 914 as application data 916. Examples of application data 916 include web pages, text, images, tables, sound files, video data, and other data. In examples, application data 916 is sent to and/or received from one or more network servers or other devices via one or more wired or wireless networks. Storage 920 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

In examples, a user enters commands and information into computing device 902 through one or more input devices 930 and receives information from computing device 902 through one or more output devices 950. Input device(s) 930 includes one or more of touch screen 932, microphone 934, camera 936, physical keyboard 938 and/or trackball 940 and output device(s) 950 includes one or more of speaker 952 and display 954. Each of input device(s) 930 and output device(s) 950 are integral to computing device 902 (e.g., built into a housing of computing device 902) or are external to computing device 902 (e.g., communicatively coupled wired or wirelessly to computing device 902 via wired interface(s) 980 and/or wireless modem(s) 960). Further input devices 930 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 954 displays information, as well as operating as touch screen 932 by receiving user commands and/or other information (e.g., by touch, finger gestures, virtual keyboard, etc.) as a user interface. Any number of each type of input device(s) 930 and output device(s) 950 are present, including multiple microphones 934, multiple cameras 936, multiple speakers 952, and/or multiple displays 954.

In embodiments where GPU 942 is present, GPU 942 includes hardware (e.g., one or more integrated circuit chips that implement one or more of processing cores, multiprocessors, compute units, etc.) configured to accelerate computer graphics (two-dimensional (2D) and/or three-dimensional (3D)), perform image processing, and/or execute further parallel processing applications (e.g., training of neural networks, etc.). Examples of GPU 942 perform calculations related to 3D computer graphics, include 2D acceleration and framebuffer capabilities, accelerate memory-intensive work of texture mapping and rendering polygons, accelerate geometric calculations such as the rotation and translation of vertices into different coordinate systems, support programmable shaders that manipulate vertices and textures, perform oversampling and interpolation techniques to reduce aliasing, and/or support very high-precision color spaces.

In examples, NPU 944 (also referred to as an “artificial intelligence (AI) accelerator” or “deep learning processor (DLP)”) is a processor or processing unit configured to accelerate artificial intelligence and machine learning applications, such as execution of machine learning (ML) model (MLM) 928. In an example, NPU 944 is configured for a data-driven parallel computing and is highly efficient at processing massive multimedia data such as videos and images and processing data for neural networks. NPU 944 is configured for efficient handling of AI-related tasks, such as speech recognition, background blurring in video calls, photo or video editing processes like object detection, etc.

In embodiments disclosed herein that implement ML models, NPU 944 can be utilized to execute such ML models, of which MLM 928 is an example. For instance, where applicable, MLM 928 is a generative AI model that generates content that is complex, coherent, and/or original. For instance, a generative AI model can create sophisticated sentences, lists, ranges, tables of data, images, essays, and/or the like. An example of a generative AI model is a language model. A language model is a model that estimates the probability of a token or sequence of tokens occurring in a longer sequence of tokens. In this context, a “token” is an atomic unit that the model is training on and making predictions on. Examples of a token include, but are not limited to, a word, a character (e.g., an alphanumeric character, a blank space, a symbol, etc.), a sub-word (e.g., a root word, a prefix, or a suffix). In other types of models (e.g., image based models) a token may represent another kind of atomic unit (e.g., a subset of an image). Examples of language models applicable to embodiments herein include large language models (LLMs), text-to-image AI image generation systems, text-to-video AI generation systems, etc. A large language model (LLM) is a language model that has a high number of model parameters. In examples, an LLM has millions, billions, trillions, or even greater numbers of model parameters. Model parameters of an LLM are the weights and biases the model learns during training. Some implementations of LLMs are transformer-based LLMs (e.g., the family of generative pre-trained transformer (GPT) models). A transformer is a neural network architecture that relies on self-attention mechanisms to transform a sequence of input embeddings into a sequence of output embeddings (e.g., without relying on convolutions or recurrent neural networks).

In further examples, NPU 944 is used to train MLM 928. To train MLM 928, training data is that includes input features (attributes) and their corresponding output labels/target values (e.g., for supervised learning) is collected. A training algorithm is a computational procedure that is used so that MLM 928 learns from the training data. Parameters/weights are internal settings of MLM 928 that are adjusted during training by the training algorithm to reduce a difference between predictions by MLM 928 and actual outcomes (e.g., output labels). In some examples, MLM 928 is set with initial values for the parameters/weights. A loss function measures a dissimilarity between predictions by MLM 928 and the target values, and the parameters/weights of MLM 928 are adjusted to minimize the loss function. The parameters/weights are iteratively adjusted by an optimization technique, such as gradient descent. In this manner, MLM 928 is generated through training by NPU 944 to be used to generate inferences based on received input feature sets for particular applications. MLM 928 is generated as a computer program or other type of algorithm configured to generate an output (e.g., a classification, a prediction/inference) based on received input features, and is stored in the form of a file or other data structure.

In examples, such training of MLM 928 by NPU 944 is supervised or unsupervised. According to supervised learning, input objects (e.g., a vector of predictor variables) and a desired output value (e.g., a human-labeled supervisory signal) train MLM 928. The training data is processed, building a function that maps new data on expected output values. Example algorithms usable by NPU 944 to perform supervised training of MLM 928 in particular implementations include support-vector machines, linear regression, logistic regression, Naïve Bayes, linear discriminant analysis, decision trees, K-nearest neighbor algorithm, neural networks, and similarity learning.

In an example of supervised learning where MLM 928 is an LLM, MLM 928 can be trained by exposing the LLM to (e.g., large amounts of) text (e.g., predetermined datasets, books, articles, text-based conversations, webpages, transcriptions, forum entries, and/or any other form of text and/or combinations thereof). In examples, training data is provided from a database, from the Internet, from a system, and/or the like. Furthermore, an LLM can be fine-tuned using Reinforcement Learning with Human Feedback (RLHF), where the LLM is provided the same input twice and provides two different outputs and a user ranks which output is preferred. In this context, the user’s ranking is utilized to improve the model. Further still, in example embodiments, an LLM is trained to perform in various styles, e.g., as a completion model (a model that is provided a few words or tokens and generates words or tokens to follow the input), as a conversation model (a model that provides an answer or other type of response to a conversation-style prompt), as a combination of a completion and conversation model, or as another type of LLM model.

According to unsupervised learning, MLM 928 is trained to learn patterns from unlabeled data. For instance, in embodiments where MLM 928 implements unsupervised learning techniques, MLM 928 identifies one or more classifications or clusters to which an input belongs. During a training phase of MLM 928 according to unsupervised learning, MLM 928 tries to mimic the provided training data and uses the error in its mimicked output to correct itself (i.e., correct weights and biases). In further examples, NPU 944 perform unsupervised training of MLM 928 according to one or more alternative techniques, such as Hopfield learning rule, Boltzmann learning rule, Contrastive Divergence, Wake Sleep, Variational Inference, Maximum Likelihood, Maximum A Posteriori, Gibbs Sampling, and backpropagating reconstruction errors or hidden state reparameterizations.

Note that NPU 944 need not necessarily be present in all ML model embodiments. In embodiments where ML models are present, any one or more of processor 910, GPU 942, and/or NPU 944 can be present to train and/or execute MLM 928.

One or more wireless modems 960 can be coupled to antenna(s) (not shown) of computing device 902 and can support two-way communications between processor 910 and devices external to computing device 902 through network 904, as would be understood to persons skilled in the relevant art(s). Wireless modem 960 is shown generically and can include a cellular modem 966 for communicating with one or more cellular networks, such as a GSM network for data and voice communications within a single cellular network, between cellular networks, or between the mobile device and a public switched telephone network (PSTN). In examples, wireless modem 960 also or alternatively includes other radio-based modem types, such as a Bluetooth modem 964 (also referred to as a “Bluetooth device”) and/or Wi-Fi modem 962 (also referred to as an “wireless adaptor”). Wi-Fi modem 962 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 964 is configured to communicate with another Bluetooth-capable device according to the Bluetooth short-range wireless technology standard(s) such as IEEE 802.15.1 and/or managed by the Bluetooth Special Interest Group (SIG).

Computing device 902 can further include power supply 982, LI receiver 984, accelerometer 986, and/or one or more wired interfaces 980. Example wired interfaces 980 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, and/or an Ethernet port, the purposes and functions of each of which are well known to persons skilled in the relevant art(s). Wired interface(s) 980 of computing device 902 provide for wired connections between computing device 902 and network 904, or between computing device 902 and one or more devices/peripherals when such devices/peripherals are external to computing device 902 (e.g., a pointing device, display 954, speaker 952, camera 936, physical keyboard 938, etc.). Power supply 982 is configured to supply power to each of the components of computing device 902 and receives power from a battery internal to computing device 902, and/or from a power cord plugged into a power port of computing device 902 (e.g., a USB port, an A/C power port). LI receiver 984 is useable for location determination of computing device 902 and in examples includes a satellite navigation receiver such as a Global Positioning System (GPS) receiver and/or includes other type of location determiner configured to determine location of computing device 902 based on received information (e.g., using cell tower triangulation, etc.). Accelerometer 986, when present, is configured to determine an orientation of computing device 902.

Note that the illustrated components of computing device 902 are not required or all-inclusive, and fewer or greater numbers of components can be present as would be recognized by one skilled in the art. In examples, computing device 902 includes one or more of a gyroscope, barometer, proximity sensor, ambient light sensor, digital compass, etc. In an example, processor 910 and memory 956 are co-located in a same semiconductor device package, such as being included together in an integrated circuit chip, FPGA, or system-on-chip (SOC), optionally along with further components of computing device 902.

In embodiments, computing device 902 is configured to implement any of the above-described features of flowcharts herein. Computer program logic for performing any of the operations, steps, and/or functions described herein is stored in storage 920 and executed by processor 910.

In some embodiments, server infrastructure 970 is present in computing environment 900 and is communicatively coupled with computing device 902 via network 904. Server infrastructure 970, when present, is a network-accessible server set (e.g., a cloud-based environment or platform). As shown in FIG. 9, server infrastructure 970 includes clusters 972. Each of clusters 972 comprises a group of one or more compute nodes and/or a group of one or more storage nodes. For example, as shown in FIG. 9, cluster 972 includes nodes 974. Each of nodes 974 are accessible via network 904 (e.g., in a “cloud-based” embodiment) to build, deploy, and manage applications and services. In examples, any of nodes 974 is a storage node that comprises a plurality of physical storage disks, SSDs, and/or other physical storage devices that are accessible via network 904 and are configured to store data associated with the applications and services managed by nodes 974.

Each of nodes 974, as a compute node, comprises one or more server computers, server systems, and/or computing devices. For instance, a node 974 in accordance with an embodiment includes one or more of the components of computing device 902 disclosed herein. Each of nodes 974 is configured to execute one or more software applications (or “applications”) and/or services and/or manage hardware resources (e.g., processors, memory, etc.), which are utilized by users (e.g., customers) of the network-accessible server set. In examples, as shown in FIG. 9, nodes 974 includes a node 946 that includes storage 948 and/or one or more of a processor 958 (e.g., similar to processor 910, GPU 942, and/or NPU 944 of computing device 902). Storage 948 stores application programs 976 and application data 978. Processor(s) 958 operate application programs 976 which access and/or generate related application data 978. In an implementation, nodes such as node 946 of nodes 974 operate or comprise one or more virtual machines, with each virtual machine emulating a system architecture (e.g., an operating system), in an isolated manner, upon which applications such as application programs 976 are executed.

In embodiments, one or more of clusters 972 are located/co-located (e.g., housed in one or more nearby buildings with associated components such as backup power supplies, redundant data communications, environmental controls, etc.) to form a datacenter, or are arranged in other manners. Accordingly, in an embodiment, one or more of clusters 972 are included in a datacenter in a distributed collection of datacenters. In embodiments, exemplary computing environment 900 comprises part of a cloud-based platform.

In an embodiment, computing device 902 accesses application programs 976 for execution in any manner, such as by a client application and/or a browser at computing device 902.

In an example, for purposes of network (e.g., cloud) backup and data security, computing device 902 additionally and/or alternatively synchronizes copies of application programs 914 and/or application data 916 to be stored at network-based server infrastructure 970 as application programs 976 and/or application data 978. In examples, operating system 912 and/or application programs 914 include a file hosting service client configured to synchronize applications and/or data stored in storage 920 at network-based server infrastructure 970.

In some embodiments, on-premises servers 992 are present in computing environment 900 and are communicatively coupled with computing device 902 via network 904. On-premises servers 992, when present, are hosted within an organization’s infrastructure and, in many cases, physically onsite of a facility of that organization. On-premises servers 992 are controlled, administered, and maintained by IT (Information Technology) personnel of the organization or an IT partner to the organization. Application data 998 can be shared by on-premises servers 992 between computing devices of the organization, including computing device 902 (when part of an organization) through a local network of the organization, and/or through further networks accessible to the organization (including the Internet). Furthermore, in examples, on-premises servers 992 serve applications such as application programs 996 to the computing devices of the organization, including computing device 902. Accordingly, in examples, on-premises servers 992 include storage 994 (which includes one or more physical storage devices such as storage disks and/or SSDs) for storage of application programs 996 and application data 998 and include a processor 990 (e.g., similar to processor 910, GPU 942, and/or NPU 944 of computing device 902) for execution of application programs 996. In some embodiments, multiple processors 990 are present for execution of application programs 996 and/or for other purposes. In further examples, computing device 902 is configured to synchronize copies of application programs 914 and/or application data 916 for backup storage at on-premises servers 992 as application programs 996 and/or application data 998.

Embodiments described herein may be implemented in one or more of computing device 902, network-based server infrastructure 970, and on-premises servers 992. For example, in some embodiments, computing device 902 is used to implement systems, clients, or devices, or components/subcomponents thereof, disclosed elsewhere herein. In other embodiments, a combination of computing device 902, network-based server infrastructure 970, and/or on-premises servers 992 is used to implement the systems, clients, or devices, or components/subcomponents thereof, disclosed elsewhere herein.

As used herein, the terms “computer program medium,” “computer-readable medium,” “computer-readable storage medium,” and “computer-readable storage device,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 920. Such computer-readable media and/or storage media are distinguished from and non-overlapping with communication media, propagating signals, and signals per se. Stated differently, “computer program medium,” “computer-readable medium,” “computer-readable storage medium,” and “computer-readable storage device” do not encompass communication media, propagating signals, and signals per se. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 914) are stored in storage 920. Such computer programs can also be received via wired interface(s) 960 and/or wireless modem(s) 960 over network 904. Such computer programs, when executed or loaded by an application, enable computing device 902 to implement features of embodiments discussed herein. Accordingly, such computer programs represent controllers of the computing device 902.

Embodiments are also directed to computer program products comprising computer code or instructions stored on any computer-readable medium or computer-readable storage medium. Such computer program products include the physical storage of storage 920 as well as further physical storage types.

### IV. Additional Example Embodiments

In embodiments, an integrated circuit for performing a remote direct memory access (RDMA) network operation with forward error correction (FEC) comprises: a data loader configured to load a message from memory, the message associated with a connection identifier; an error correction module configured to: logically divide the message into a first predetermined number of data blocks, and determine a second predetermined number of parity blocks based on the data blocks; and a network module configured to: determine a set of source port numbers associated with the connection identifier, and transmit the data blocks and parity blocks using different source port numbers from the set of source port numbers.

In embodiments, the integrated circuit further comprises: a lookup module configured to: receive a data block and a corresponding index value; determine an entry of a lookup table based on the index value; determine values in the determined entry corresponding to fixed-width portions of the data block by performing shuffle operations on the entry of the lookup table based on values of the fixed-width portions; and provide an output value comprising a concatenation of the determined values.

In embodiments, to determine the second predetermined number of parity blocks, the error correction module is configured to: determine corresponding index values for the data blocks; provide a series of pairs of the data blocks and the corresponding index values to the lookup module; receive a series of output values from the lookup module; and perform exclusive-OR (XOR) operations across the series of output values.

In embodiments, the lookup table comprises: a multiplication table comprising precomputed values associated with Galois field multiplication operations.

In embodiments, the error correction module is further configured to: store a parity block in a memory of the integrated circuit during a first clock cycle; and retrieve the stored parity block from the memory of the integrated circuit during a second clock cycle.

In embodiments, to transmit the data blocks and the parity blocks, the network module is configured to: generate packets to perform RDMA network operations, the packets comprising a particular block of the data blocks or the parity blocks and an immediate value, the immediate value comprising a message identifier that identifies the message and at least one of: a block identifier that identifies the particular block, or a path identifier associated with a transmission path of the packet.

In embodiments, to transmit the data blocks and the parity blocks, the network module is configured to: transmit the packets to a network node configured to perform equal-cost multi-path (ECMP) routing to forward the packets to a destination over different network paths.

In embodiments, the network module is further configured to: determine that a first path associated with a first source port number of the set of source port numbers satisfies a predetermined performance condition; and replace the first source port number in the set of port numbers with a replacement source port number.

In embodiments, the integrated circuit further comprises: a request processor configured to: receive, from an application, a request to send the message from a send buffer to a receive buffer, the request comprising a destination address and memory key of the receive buffer, a message identifier associated with the message, a first parameter indicating the first predetermined number, and a second parameter indicating the second predetermined number; and cause the data loader to load the message from the send buffer.

In embodiments, the integrated circuit is implemented using at least one of: field-programmable gate arrays (FPGAs); or an application-specific integrated circuit (ASIC).

In embodiments, a method for performing a remote direct memory access (RDMA) network operation with forward error correction (FEC) using an integrated circuit comprises: loading a message from memory, the message associated with a connection identifier; logically dividing the message into a first predetermined number of data blocks; determining a second predetermined number of parity blocks based on the data blocks; determining a set of source port numbers associated with the connection identifier; and transmitting the data blocks and parity blocks using different source port numbers from the set of source port numbers.

In embodiments, determining the second predetermined number of parity blocks comprises: determining corresponding index values for the data blocks; providing a series of pairs of the data blocks and the corresponding index values to a lookup module; receiving a series of output values from the lookup module; and performing exclusive-OR (XOR) operations across the series of output values.

In embodiments, the method further comprises: receiving, by the lookup module, a data block and a corresponding index value; determining, by the lookup module, an entry of a lookup table based on the index value; determining, by the lookup module, values in the entry corresponding to fixed-width portions of the data block by performing shuffle operations on the entry of the lookup table based on values of the fixed-width portions; and providing, by the lookup module, an output value comprising a concatenation of the values.

In embodiments, the lookup table comprises: a multiplication table comprising precomputed values associated with Galois field multiplication operations.

In embodiments, the method further comprises: storing a parity block of the parity blocks in a memory of the integrated circuit during a first clock cycle; and retrieving the stored parity block from the memory of the integrated circuit during a second clock cycle.

In embodiments, transmitting the data blocks and the parity blocks comprises: generating packets to RDMA network operations, the packets comprising a particular block of the data blocks or the parity blocks and an immediate value, the immediate value comprising a message identifier that identifies the message and at least one of: a block identifier that identifies the particular block, or a path identifier associated with a transmission path of the packet.

In embodiments, transmitting the data blocks and the parity blocks comprises: transmitting the packets to a network node configured to perform equal-cost multi-path (ECMP) routing to forward the packets to a destination over different network paths.

In embodiments, the method further comprises: determining that a first path associated with a first source port number of the set of source port numbers satisfies a predetermined performance condition; and replacing the first source port number in the set of port numbers with a replacement source port number.

In embodiments, the method further comprises: receiving, from an application, a request to send the message from a send buffer to a receive buffer, the request comprising a destination address and memory key of the receive buffer, a message identifier associated with the message, a first parameter indicating the first predetermined number, and a second parameter indicating the second predetermined number.

In embodiments, the integrated circuit is implemented using at least one of: field-programmable gate arrays (FPGAs); or an application-specific integrated circuit (ASIC).

### V. Conclusion

References in the specification to "one embodiment," "an embodiment," "an example embodiment," etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended. Furthermore, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

While various embodiments of the present disclosure have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. An integrated circuit for performing a remote direct memory access (RDMA) network operation with forward error correction (FEC), the integrated circuit comprising:
a data loader configured to load a message from memory, the message associated with a connection identifier;
an error correction module configured to:
logically divide the message into a first predetermined number of data blocks, and
determine a second predetermined number of parity blocks based on the data blocks; and
a network module configured to:
determine a set of source port numbers associated with the connection identifier, and
transmit the data blocks and parity blocks using different source port numbers from the set of source port numbers.

2. The integrated circuit of claim 1, further comprising:
a lookup module configured to:
receive a data block and a corresponding index value;
determine an entry of a lookup table based on the index value;
determine values in the entry corresponding to fixed-width portions of the data block by performing shuffle operations on the entry of the lookup table based on values of the fixed-width portions; and
provide an output value comprising a concatenation of the values.

3. The integrated circuit of claim 2, wherein, to determine the second predetermined number of parity blocks, the error correction module is configured to:
determine corresponding index values for the data blocks;
provide a series of pairs of the data blocks and the corresponding index values to the lookup module;
receive a series of output values from the lookup module; and
perform exclusive-OR (XOR) operations across the series of output values.

4. The integrated circuit of claim 2, wherein the lookup table comprises:
a multiplication table comprising precomputed values associated with Galois field multiplication operations.

5. The integrated circuit of claim 1, wherein the error correction module is further configured to:
store a parity block in a memory of the integrated circuit during a first clock cycle; and
retrieve the stored parity block from the memory of the integrated circuit during a second clock cycle.

6. The integrated circuit of claim 1, wherein, to transmit the data blocks and the parity blocks, the network module is configured to:
generate packets to perform the RDMA operation, the packets comprising a particular block of the data blocks or the parity blocks and an immediate value, the immediate value comprising a message identifier that identifies the message and at least one of:
a block identifier that identifies the particular block, or
a path identifier associated with a transmission path of the packet.

7. The integrated circuit of claim 6, wherein, to transmit the data blocks and the parity blocks, the network module is configured to:
transmit the packets to a network node configured to perform equal-cost multi-path (ECMP) routing to forward the packets to a destination over different network paths.

8. The integrated circuit of claim 1, wherein the network module is further configured to:
determine that a first path associated with a first source port number of the set of source port numbers satisfies a predetermined performance condition; and
replace the first source port number in the set of port numbers with a replacement source port number.

9. The integrated circuit of claim 1, further comprising:
a request processor configured to:
receive, from an application, a request to send the message from a send buffer to a receive buffer, the request comprising a destination address and memory key of the receive buffer, a message identifier associated with the message, a first parameter indicating the first predetermined number, and a second parameter indicating the second predetermined number; and
cause the data loader to load the message from the send buffer.

10. The integrated circuit of claim 1, wherein the integrated circuit is implemented using at least one of:
field-programmable gate arrays (FPGAs); or
an application-specific integrated circuit (ASIC).

11. A method for performing a remote direct memory access (RDMA) network operation with forward error correction (FEC) using an integrated circuit, the method comprising:
loading a message from memory, the message associated with a connection identifier;
logically dividing the message into a first predetermined number of data blocks;
determining a second predetermined number of parity blocks based on the data blocks;
determining a set of source port numbers associated with the connection identifier; and
transmitting the data blocks and parity blocks using different source port numbers from the set of source port numbers.

12. The method of claim 11, wherein said determining the second predetermined number of parity blocks comprises:
determining corresponding index values for the data blocks;
providing a series of pairs of the data blocks and the corresponding index values to a lookup module;
receiving a series of output values from the lookup module; and
performing exclusive-OR (XOR) operations across the series of output values.

13. The method of claim 12, further comprising:
receiving, by the lookup module, a data block and a corresponding index value;
determining, by the lookup module, an entry of a lookup table based on the index value;
determining, by the lookup module, values in the entry corresponding to fixed-width portions of the data block by performing shuffle operations on the entry of the lookup table based on values of the fixed-width portions; and
providing, by the lookup module, an output value comprising a concatenation of the determined values.

14. The method of claim 13, wherein the lookup table comprises:
a multiplication table comprising precomputed values associated with Galois field multiplication operations.

15. The method of claim 11, further comprising:
storing a parity block of the parity blocks in a memory of the integrated circuit during a first clock cycle; and
retrieving the stored parity block from the memory of the integrated circuit during a second clock cycle.

16. The method of claim 11, wherein said transmitting the data blocks and the parity blocks comprises:
generating packets to perform the RDMA network operation, the packets comprising a particular block of the data blocks or the parity blocks and an immediate value, the immediate value comprising a message identifier that identifies the message and at least one of:
a block identifier that identifies the particular block, or
a path identifier associated with a transmission path of the packet.

17. The method of claim 16, wherein said transmitting the data blocks and the parity blocks comprises:
transmitting the packets to a network node configured to perform equal-cost multi-path (ECMP) routing to forward the packets to a destination over different network paths.

18. The method claim 11, further comprising:
determining that a first path associated with a first source port number of the set of source port numbers satisfies a predetermined performance condition; and
replacing the first source port number in the set of port numbers with a replacement source port number.

19. The method of claim 11, further comprising:
receiving, from an application, a request to send the message from a send buffer to a receive buffer, the request comprising a destination address and memory key of the receive buffer, a message identifier associated with the message, a first parameter indicating the first predetermined number, and a second parameter indicating the second predetermined number.

20. The method of claim 11, wherein the integrated circuit is implemented using at least one of:
field-programmable gate arrays (FPGAs); or
an application-specific integrated circuit (ASIC).
